(19) United States
(12) Patent Application Publication
(10) Pub. No.: US 2011/0278463 A1
(43) Pub. Date: Nov. 17, 2011

(54) Radiation Detector And Method For Producing A Radiation Detector

(75) Inventors: Michael Miess, Baiersdorf (DE); Stefan Wirth, Erlangen (DE)

(73) Assignee: SIEMENS AKTIENGESELLSCHAFT, Munich (DE)

(21) Appl. No.: 13/106,896

(22) Filed: May 13, 2011

(30) Foreign Application Priority Data
May 14, 2010 (DE) 10 2010 020 610.5

(51) Int. Cl. G01T 1/20; B32B 38/04; B32B 37/00

(52) U.S. Cl. 250/361 R; 156/257; 156/153; 156/245

(57) ABSTRACT

A radiation detector is disclosed, which in at least one embodiment includes a scintillator with septa for separating scintillator elements arranged alongside one another, and a collimator with webs for forming laterally enclosed radiation channels, wherein the webs are inserted into the septa in order to avoid crosstalk between adjacent scintillator elements. This effectively suppresses crosstalk by light or secondary quanta between adjacent pixels in conjunction with a simple construction and high mechanical stability with the consequence that the spatial resolution and quantum efficiency of the radiation detector can be increased. At least one embodiment additionally relates to a method for producing such a radiation detector.

### PRIORITY STATEMENT

The present application hereby claims priority under 35 U.S.C. §119 on German patent application number DE 10 2010 020 610.5 filed May 14, 2010, the entire contents of which are hereby incorporated herein by reference.

### FIELD

At least one embodiment of the invention generally relates to a radiation detector and/or a method for producing a radiation detector.

### BACKGROUND

Radiation detectors are used for example in computered tomography apparatus for converting x-rays into electrical signals which serve as a basis for calculating two or three-dimensional slice images of a patient to be examined. So-called indirectly converting radiation detectors are usually used, in which the conversion of the x-rays into electrical signals is effected in two stages. In a first stage, the x-ray quanta are absorbed in a scintillator and converted into optically visible light signals. The light signals are subsequently converted into electrical signals in a second stage by way of a photodiode array optically coupled to the scintillator, then said signals are read out by way of read-out electronics and subsequently forwarded to a computing unit.

By way of example, materials doped with activators such as Gd₂O₂S:Pr or CsI:Tl are appropriate as scintillator material. For the spatially resolved detection of the absorption events, the scintillator is in this case structured into individual scintillator elements that are separated from one another by septa. The light signals generated by x-ray quanta propagate substantially isotropically in the scintillator, which leads to a certain crosstalk of a portion of the light signals to scintillator elements arranged adjacent, and thus leads to an impairment of the spatial resolution.

In order to suppress this lateral light propagation and in order to obtain good separation of the light signals between the scintillator elements, for this reason the septa are usually filled with a septa material that reflects back or scatters back a certain proportion of the generated light signals into the scintillator element. A binder matrix with which a pulverulent material having a high refractive index, for example TiO₂ particles, is admixed is appropriate as septa material. The backscattering effect and thus the spatial resolution increase with increasing width of the septa serving for accommodating the reflective material between adjacent scintillator elements.

However, a widening of the septa inevitably also leads to a reduction of the active pixel area and thus to a reduction of the quantum efficiency. On account of that, in the case of the known radiation detectors, it is necessary to choose a compromise between the quantum efficiency and the crosstalk behavior. As a further measure for increasing a quantum efficiency, a covering reflector is applied on the radiation entrance side of the scintillator, said covering reflector being intended to prevent light from emerging.

Besides the optical crosstalk, a further crosstalk is brought about by the fact that after the primary reaction of an x-ray quantum, secondary quanta are produced in the scintillator material by scattering or by k-escape, and they pass into adjacent scintillator elements and generate a light signal there. This effect cannot be prevented by the septa materials used hitherto. Despite these measures it is not unusual for only approximately 30% of the generated light signals to be acquired by the photodiodes for signal conversion, 40% being lost by virtue of absorption losses in the scintillatory material and approximately 30% as a result of crosstalk to adjacent scintillator elements.

However, the spatial resolution and the noise of the electrical signal generated are not only impaired by the interactions of the x-ray radiation in the scintillator material as just described. The x-ray radiation emerging from the x-ray source is already scattered in the object, such that, besides the primary rays from the x-ray source, scattered rays also impinge on adjacent scintillator elements.

In order to reduce scattered radiation influences, therefore, a collimator is disposed upstream of the scintillator, said collimator having the effect that only x-rays having a specific spatial direction pass to the scintillator elements. In this way image artifacts can be reduced and for a given contrast to noise ratio, the x-ray dose applied to a patient can be significantly reduced. The collimator is usually mounted only after the process of joining together the scintillator with the photodiode array. At this point in time, however, the position of the septa in the scintillator is no longer visible optically since the septa are concealed by the covering reflector applied on the radiation entrance side. Therefore, the collimator is alternatively oriented with respect to the outer edges of the scintillator with the inclusion of prior knowledge about the position of the septa in relation to the outer edges of the scintillator.

However, the positions of the septa in the scintillator have inaccuracies caused by manufacturing tolerances with regard to the outer edge. As a result, the relative position of the collimator with respect to the septa is also beset by a tolerance. In order to take account of this tolerance in the positioning of the collimator, it is necessary for the septa width to be chosen to be correspondingly large in order to ensure that the collimated radiation in each case impinges only on the envisaged detector element and does not spill over to adjacent detector elements.

However, as already explained above, an increase in the septa width is simultaneously associated with a reduction of the radiation entrance area of the scintillator elements. In the case of incorrect positioning of the collimator there is additionally the risk of shading of the radiation entrance area that is caused by the collimator. In both cases, this leads to a reduction of the quantum efficiency.

### SUMMARY

In at least one embodiment of the present invention, a radiation detector and a method for producing a radiation detector are configured in such a way as to provide the prerequisites for increasing an effective luminous efficiency and improving the spatial resolution.

At least one embodiment is directed to a radiation detector, and also at least one embodiment is directed to a method for producing such a radiation detector. Dependent claims relate to advantageous configurations and refinements.

The radiation detector according to at least one embodiment of the invention comprises a scintillator with septa for separating scintillator elements arranged alongside one another, and comprises a collimator with webs for forming laterally enclosed radiation channels, wherein the webs are inserted into the septa in order to avoid crosstalk between adjacent scintillator elements.

In this context, a septum is understood to mean the interspace formed between adjacent scintillator elements, which is usually channel-shaped. Crosstalk between adjacent scintillator elements means that radiation passes into a scintillator element arranged adjacent this being taken to mean the radiation that is brought about directly or indirectly by interaction of an x-ray quantum passing into a scintillator element. The radiation can correspondingly be a generated light signal, but also a secondary quantum having a wavelength in or near the range of an x-ray radiation.

According to at least one embodiment of the invention, the webs of the collimator perform a double function. Firstly, in the region upstream of the scintillator they serve, as is known, for masking out scattered rays that arise as a result of interaction of the primary rays with the object. In addition, within the scintillator, they now also serve for avoiding crosstalk between adjacent scintillator elements which is brought about by secondary quanta generated in the syntillation material or by lateral light propagation of the light signals generated in the scintillator material. In the scintillator, therefore, the webs of the collimator replace the filling material that is usually introduced into the septa.

This has a series of advantages: in this way the septa can be adapted very precisely to the respective web width of the collimator. Specifically in the design of the width of the septa, it is no longer necessary to take account of tolerances with regard to the relative position between the septa and the webs, such as are expected in the case of mounting by indirect positioning of the collimator over the outer edges of the scintillator. In comparison with the known cases, the septa width can therefore be chosen to be correspondingly smaller in the case of the radiation detector according to the invention, such that the radiation entrance area is enlarged and the effective luminous efficiency is thus increased.

To put it another way, this means that the positioning accuracy of the collimator relative to the scintillator is increased by the direct insertion of the webs into the septa. In particular, introducing the collimator material between the scintillator elements avoids crosstalk by secondary rays since the collimator material is highly absorbent toward x-ray radiation in a functionally governed fashion. Furthermore, optical crosstalk is also completely suppressed since it is not transparent in the optical region either. With these measures, therefore, improved separation of the generated light signals can be obtained in a simple way. As a result, the spatial resolution is increased and the noise in the generated electrical signal is reduced.

In order to increase the effective luminous efficiency, at least the region of the webs which is inserted into the septa has a coating that is reflective in the wavelength range of a light generated by the scintillator. In this way, the light signals are reflected back upon lateral propagation into the scintillator element and directed onto the photodiode, in which they are converted into an electrical signal. Before impingement on the photodiode, multiple reflections at the reflective layers of the scintillator walls also come into consideration.

The coating preferably comprises titanium oxide or a metal, in particular aluminum or silver. These materials have a high refractive index for the light generated by the scintillator, are readily available and can be applied by conventional methods to at least the region of the webs which is inserted into the septa. By way of example, a coating can advantageously be produced by applying or spraying a composite material admixed with titanium oxide onto the region of the webs. The webs could, of course, also be correspondingly wetted by dipping the webs into said composite material. As an alternative thereto, a coating can advantageously be produced by vapor deposition or deposition of a metal, in particular of aluminum or silver, onto the region of the webs. By using an electrolytic deposition method it is possible, in particular, to produce very thin layers with at the same time high reflectivity.

In one advantageous configuration of at least one embodiment of the invention, the webs of the collimator are produced from molybdenum, tantalum, tungsten or an alloy of these elements. On account of the comparatively high atomic number, such materials have a high absorption coefficient in the wavelength range of the x-rays. Consequently inserting the webs into the septa also effectively prevents crosstalk of secondary quanta generated in the scintillator in or near the wavelength range of the x-rays.

The webs in the septa are preferably fixed by way of a composite material. In one advantageous configuration of at least one embodiment of the invention, the composite material is an adhesive comprising a reflective material, preferably titanium oxide or aluminum. A high mechanical stability of the radiation detector can be obtained as a result.

As a result of insertion into the septa, therefore, the webs of the collimator are not only fixed in one plane with the scintillator on the radiation entrance side. As a result of the insertion of the webs into the septa, the fixing is effected, in principle, in a plurality of planes, for example additionally in planes running perpendicularly to the radiation entrance side. This increases the mechanical stability of these components with respect to one another.

In one preferred example embodiment of the invention, the collimator is produced by way of a rapid manufacturing technique, in particular by way of selective laser melting, or by way of an injection molding technique.

In particular, selective laser melting is advantageously appropriate as the rapid manufacturing technique. As a result, the webs of the collimator have a very high accuracy in terms of their width, height and also position. In particular, very thin webs can be realized. In this case, the collimator produced in this way is an integral component with webs in both the φ- and the z-direction, and not a composition composed of a plurality of individual sheets. Therefore, it has a particularly high mechanical strength.

A second aspect of at least one embodiment of the invention relates to a method for producing a radiation detector comprising a scintillator and a collimator, comprising the following method steps:
a) producing a scintillator with septa,
b) producing a collimator with webs,
c) introducing an adhesive into the septa,
d) inserting the webs of the collimator into the septa of the scintillator, and
e) curing the adhesive.

According to one advantageous configuration of at least one embodiment of the invention, step a) additionally comprises the following method steps:

a1) providing an unstructured scintillator layer on a carrier substrate, and
a2) sawing or slotting the septa in the φ- and z-direction into the scintillator layer. In this way, the septa can be produced with a high accuracy in a simple manner.

After step a1) preferably the following step is carried out:

a11) applying a covering reflector on a radiation entrance side of the scintillator layer. In this case, therefore, the septa are slotted through the covering reflector, such that the positions of the septa are optically visible and the webs can be inserted into the septa by way of optical control in a simple manner.

Following step a2) there are advantageously the following steps:

a3) removing the carrier substrate, and
a4) grinding and/or polishing the exposed side of the scintillator layer.

Furthermore, step b) preferably comprises the following method step:

b1) forming the webs in a layered manner along a φ- and a z-direction from a radiation-absorbing material by using a rapid manufacturing technique.

In one advantageous configuration of at least one embodiment of the invention, selective laser melting is used as the rapid manufacturing technique and molybdenum, tungsten, tantalum, or an alloy composed of these elements is used as the radiation-absorbing material.

As an alternative to the rapid manufacturing technique, the collimator can likewise advantageously be produced by way of an injection molding technique according to the following method steps:

b1) providing a mold for an injection molding technique, said mold having webs along a φ- and a z-direction, injecting a composite material admixed with a radiation-absorbing material into the mold and curing the composite material in the mold.

Preferably, an epoxy matrix is used as the composite material and molybdenum, tungsten, tantalum, or an alloy composed of these elements is used as the radiation-absorbing material.

Step b) comprises the following method step with the advantages described above:

b2) applying an optically reflective coating at least in the region of the webs which is inserted into the septa.

By way of example, the following two method steps for producing the coating can alternatively be performed: vapor deposition or deposition of a metal, in particular of aluminum or silver, or applying or spraying a composite material admixed with titanium oxide, onto the region of the webs.

### BRIEF DESCRIPTION OF THE DRAWINGS

The invention is explained in greater detail below on the basis of example embodiments and with reference to drawings, in which:

FIG. 1 shows a computed tomography apparatus with a radiation detector according to an embodiment of the invention in a schematic illustration,

FIG. 2 shows an excerpt from the radiation detector according to an embodiment of the invention in a side view, and

FIG. 3 shows a flowchart for a method for producing the radiation detector according to an embodiment of the invention.

In the figures, identical or functionally identical elements are designated by identical reference symbols. In the case of recurring elements in a figure, only one element is respectively provided with a reference symbol for reasons of clarity. The illustrations in the figures are schematic and not necessarily true to scale, in which case scales can vary between the figures.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

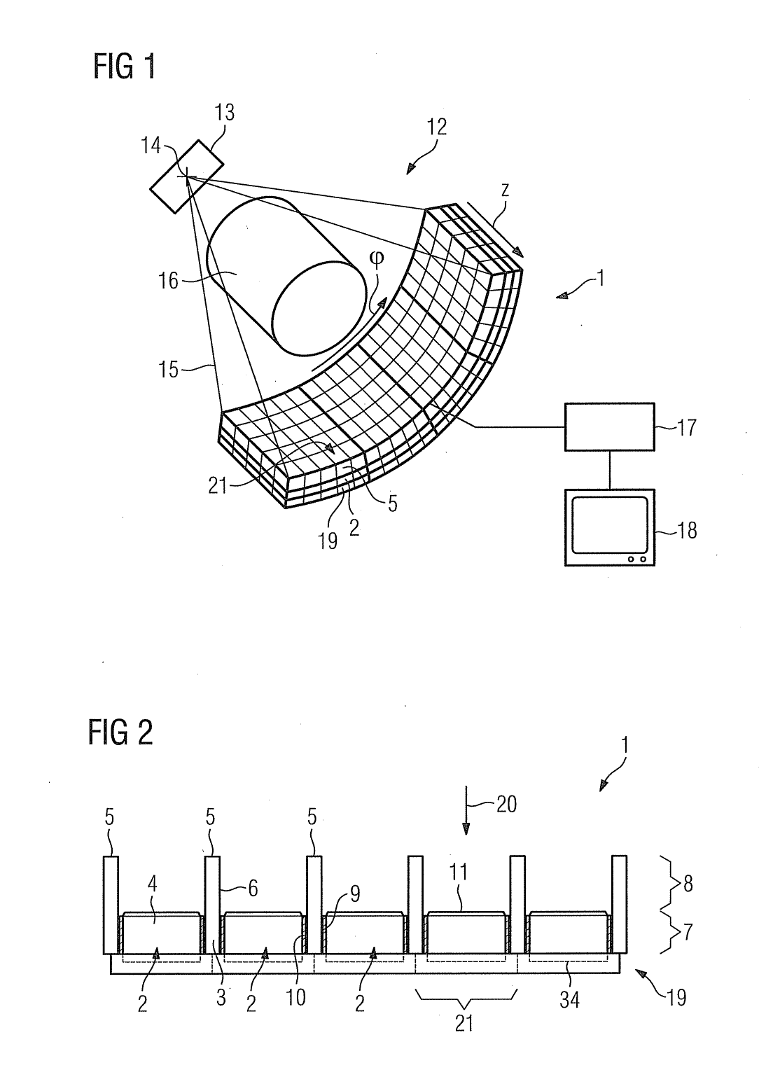

FIG. 1 shows a computed tomography apparatus 12 comprising a radiation source 13 in the form of an x-ray tube, from the focus 14 of which an x-ray beam for 15 emerges. The x-ray beam fan penetrates through an object 16 to be examined or a patient, and impinges on a radiation detector 1, here an x-ray detector.

The x-ray tube 13 and the radiation detector 1 are arranged in a manner lying opposite one another on a gantry (not shown here) in a manner rotatable about a system axis z (=patient axis) of the computed tomography apparatus 12 in the φ-direction. The φ-direction therefore represents the circumferential direction of the gantry and the z-direction represents the longitudinal direction of the object 16 to be examined.

During the operation of the computed tomography apparatus 12, the x-ray tube 13 and the radiation detector 1 rotate around the object 16, x-ray recordings of the object 16 being obtained from different projection directions. Per x-ray projection, x-rays that have passed through the object 16 and have thereby been attenuated thus impinge on the radiation detector 1. In this case, the radiation detector 1 generates electrical signals corresponding to the intensity of the x-rays that impinged thereon. From the signals detected by the radiation detector 1, an evaluation unit 17 subsequently calculates, in a manner known per se, one or more two- or three-dimensional images of the object 16, which can be displayed on a display unit 18.

The radiation detector 1 comprises as essential component parts, as shown in a side view in FIG. 2, a collimator 5 for reducing scattered rays, a scintillator 2 for converting the incident x-rays into light and a photodiode array 18 for converting the light signals into electrical signals.

The scintillator 2 is produced from a material doped with activators. The scintillator material is usually a scintillation ceramic, for example Gd₂O₂S:PR and CsI:Tl, which is deposited on a carrier substrate. A covering, reflector 11 is applied on that side of the scintillator 2 which lies opposite the carrier substrate. When the scintillator 2 is used as intended, said side corresponds to the radiation entrance side 20 of the x-rays. In the present exemplary body, the covering reflector 11 is a layer of titanium oxide which was formed by vapor deposition or spraying.

In principle, all materials which have a high refractive index in the wavelength range of the light generated by the scintillator material and have a high chemical stability with respect to x-rays and, moreover, are virtually transparent in the case of the applied layer thickness in the wavelength range of the x-rays are suitable. In this case, the light generated in the scintillator material is reflected back as a result of which the quantum efficiency is increased. For the spatially resolved detection of absorption elements, the scintillator 2 is additionally structured into individual scintillator elements 4. In this case, the scintillator elements 4 are spatially separated from one another by septa 3. The septa 3 are usually formed by slotting or milling in the φ- and z-direction through the covering reflector 11 into the scintillator ceramic. Typical septa widths are in the range of between 50 μm and 500 μm. The position of the septa 3 is thus optically visible. This enables simple positioning of the collimator 5 under optical control.

The photodiode array 19 is structured into individual photodiodes 34 in accordance with the subdivision of the scintillator 2 and is optically coupled to the scintillator 2 at the underside thereof by way of an adhesive. It would likewise be conceivable for the scintillator 2 to be deposited directly onto the photodiode array 19 and be structured.

The collimator 5 is produced from webs 6 that extend in the φ- and z-direction and are composed of any material that is highly absorbent with respect to x-rays, for example molybdenum, tungsten, tantalum or an alloy of these elements. In this case, production is effected by way of selective laser melting, that is to say by way of a rapid manufacturing technique, in a layered manner using a CAD model that can be read in a computer-aided manner. Such a collimator 5 can be produced with very high geometrical accuracy and has a high mechanical stability on account of the integral production. In the case of the radiation detector 1 according to the invention, the webs 6 of the collimator 5 are inserted into the septa 3 of the scintillator 2. In this way, the collimator 5 fulfills two different functions:

Firstly, the region 8 of the webs 6 that is situated upstream of the scintillator 2 in the radiation direction 20 serves, in the usual way, for masking out scattered rays that arise as a result of the scattering of the x-rays in the examined object 16 and have a spatial direction deviating from the focus 14 of the x-ray tube 13 in relation to the respective scintillator element 4. This is achieved by virtue of the fact that the webs 6 form in the φ- and z-direction for the respective scintillator element 4 a radiation channel whose longitudinal axis is oriented to the focus 14 of the x-ray tube 13, such that rays from a spatial direction deviating therefrom are absorbed in the webs 6.

Secondly, the region 7 of the webs 6 which is inserted into the septa 3 serves for effectively suppressing crosstalk between the scintillator elements 4 arranged in an adjacent fashion. In this case, two different types of crosstalk are avoided. The first type of crosstalk concerns crosstalk of secondary quanta to adjacent scintillator elements 4, which arise as a result of interaction processes of the x-rays arriving in the scintillator material. The secondary quanta have an energy in the wavelength range of x-rays. The materials appropriate for a collimator 5 have to have, in a functionally governed manner, a high atomic number for effectively absorbing scattered rays, such that the webs 6 inserted into the septa 3 also effectively suppress the secondary quanta. The webs 6 therefore prevent the secondary quanta within the scintillator from passing from one scintillator element 4 to the other scintillator element 4.

A second type of crosstalk concerns the optical crosstalk of the light generated in the scintillator material to adjacent scintillator elements 4. On account of the high atomic number of the material used for the collimator 5, the webs 6 are also non-transmissive in the optical wavelength range and hence for the scintillator light. Crosstalk of the generated light to an adjacent pixel 21 is thus precluded. In order to increase the quantum efficiency, the webs 6 have a coating 9 with an optically reflective material in the region 7 of the septa 3. One possibility consists, for example, in the vapor deposition or deposition of a metal, in particular of aluminum or silver, onto the webs 6. As an alternative thereto, a coating 9 can also be effected by applying or spraying on a composite material admixed with titanium oxide or with some other optically reflective material, wherein an epoxy matrix, for example, is appropriate as the composite material. The laterally propagating light is thereby reflected back into the pixel 21 and is thus available for signal conversion.

The webs 6 are fixed in the septa 3 by way of an adhesive 10. The adhesive 10 can be a UV-curable plastics composition, for example. Collimator 5 and scintillator 2 thus have high stiffness, such that an exact orientation is still ensured even at high rotational speeds.

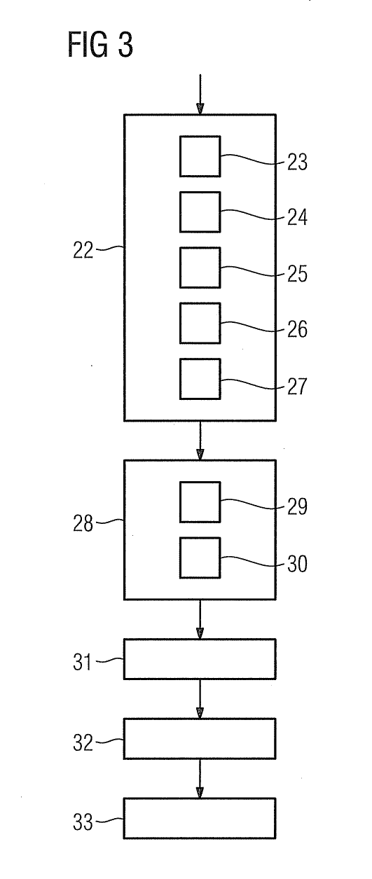

FIG. 3 shows a flowchart for a method for producing the radiation detector 1 according to an embodiment of the invention. It comprises the following method steps:
a) 22 producing a scintillator with septa, by
a1) 23 providing an unstructured scintillator layer on a carrier substrate,
a11) 24 applying a covering reflector on a radiation entrance side of the scintillator layer,
a2) 25 sawing or slotting the septa in the φ- and z-direction into the scintillator layer,
a3) 26 removing the carrier substrate,
a4) 27 grinding and/or polishing the uncovered side of the scintillator layer,
b) 28 producing a collimator with webs by
b1) 29 forming the webs in a layered manner along a φ- and a z-direction from a radiation-absorbing material by using a rapid manufacturing technique,
b2) 30 applying an optically reflective coating at least in the region of the webs which is inserted into the septa,
c) 31 introducing an adhesive into the septa,
d) 32 inserting the webs of the collimator into the septa of the scintillator, and
e) 33 curing the adhesive.

In method step b1), it is possible, in principle, to use any desired production methods for the construction of a 2D collimator. One alternative to the use of a rapid manufacturing technique is provided, for example, by the use of an injection molding technique according to the following procedure:

b1) providing a mold for an injection molding technique, said mold having webs 6 along a φ- and a z-direction, injecting a composite material admixed with a radiation-absorbing material into the mold and curing the composite material in the mold.

To summarize, it can be stated that:

At least one embodiment of the invention relates to a radiation detector 1, comprising a scintillator 2 with septa 3 for separating scintillator elements 4 arranged alongside one another, and comprising a collimator 5 with webs 6 for forming laterally enclosed radiation channels, wherein the webs 6 are inserted into the septa 3 in order to avoid crosstalk between adjacent scintillator elements 4. This effectively suppresses crosstalk by light or secondary quanta between adjacent pixels in conjunction with a simple construction and high mechanical stability with the consequence that the spatial resolution and quantum efficiency of the radiation detector 1 can be increased. The invention additionally relates to a method for producing such a radiation detector 1.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A radiation detector, comprising:
a scintillator with septa to separate scintillator elements arranged alongside one another; and
a collimator including webs to form laterally enclosed radiation channels, the webs being inserted into the septa in order to avoid crosstalk between adjacent scintillator elements.

2. The radiation detector as claimed in claim 1, wherein at least the region of the webs which is inserted into the septa includes a coating that is reflective in a wavelength range of a light generated by the scintillator.

3. The radiation detector as claimed in claim 2, wherein the coating comprises titanium oxide or a metal.

4. The radiation detector as claimed in claim 1, wherein the webs are produced from molybdenum, tantalum, tungsten or an alloy of these elements.

5. The radiation detector as claimed in claim 1, wherein the webs are fixed in the septa by way of a composite material.

6. The radiation detector as claimed in claim 5, wherein the composite material is an adhesive comprising a reflective material, in particular titanium oxide, aluminum or silver.

7. The radiation detector as claimed in claim 1, wherein the collimator is produced by way of a rapid manufacturing technique.

8. A method for producing a radiation detector comprising a scintillator and a collimator, the method comprising:
a) producing a scintillator with septa;
b) producing a collimator with webs;
c) introducing an adhesive into the septa;
d) inserting the webs of the collimator into the septa of the scintillator; and
e) curing the adhesive.

9. The method as claimed in claim 8, wherein step a) comprises:
a1) providing an unstructured scintillator layer on a carrier substrate, and
a2) sawing or slotting the septa in the φ- and z-direction into the scintillator layer.

10. The method as claimed in claim 9, wherein after step a1) at least the following is carried out:
a11) applying a covering reflector on a radiation entrance side of the scintillator layer.

11. The method as claimed in claim 9, wherein after step a2) at least the following are carried out:
a3) removing the carrier substrate, and
a4) at least one of grinding and polishing the exposed side of the scintillator layer.

12. The method as claimed in claim 8, wherein step b) comprises:
b1) forming the webs in a layered manner along a φ- and a z-direction from a radiation-absorbing material by using a rapid manufacturing technique.

13. The method as claimed in claim 12, wherein selective laser melting is used as the rapid manufacturing technique and molybdenum, tungsten, tantalum, or an alloy composed of these elements is used as the radiation-absorbing material.

14. The method as claimed in claim 8, wherein step b) comprises:
b1) providing a mold for an injection molding technique, said mold having webs along a φ- and a z-direction, injecting a composite material admixed with a radiation-absorbing material into the mold and curing the composite material in the mold.

15. The method as claimed in claim 14, wherein an epoxy matrix is used as the composite material and molybdenum, tungsten, tantalum, or an alloy composed of these elements is used as the radiation-absorbing material.

16. The method as claimed in claim 8, wherein step b) comprises:
b2) applying an optically reflective coating at least in the region of the webs which is inserted into the septa.

17. The method as claimed in claim 16, wherein step b2) comprises: vapor deposition or deposition of a metal, in particular aluminum or silver, onto the region of the webs.

18. The method as claimed in claim 16, wherein step b2) comprises: applying or spraying a composite material admixed with titanium oxide onto the region of the webs.

19. The radiation detector as claimed in claim 3, wherein the

20. The radiation detector as claimed in claim 7, wherein the collimator is produced by way of selective laser melting, or by way of an injection molding technique.

21. The method as claimed in claim 10, wherein after step a2) at least the following are carried out:
a3) removing the carrier substrate, and
a4) at least one of grinding and polishing the exposed side of the scintillator layer.

22. The method as claimed in claim 9, wherein step b) comprises:
b1) forming the webs in a layered manner along a φ- and a z-direction from a radiation-absorbing material by using a rapid manufacturing technique.

23. The method as claimed in claim 10, wherein step b) comprises:
b1) forming the webs in a layered manner along a φ- and a z-direction from a radiation-absorbing material by using a rapid manufacturing technique.

24. The method as claimed in claim 8, wherein step b) comprises:
b1) providing a mold for an injection molding technique, said mold having webs along a φ- and a z-direction, injecting a composite material admixed with a radiation-absorbing material into the mold and curing the composite material in the mold.

25. The method as claimed in claim 10, wherein step b) comprises:
b1) providing a mold for an injection molding technique, said mold having webs along a φ- and a z-direction, injecting a composite material admixed with a radiation-absorbing material into the mold and curing the composite material in the mold.

26. The method as claimed in claim 17, wherein the metal is aluminum or silver.
